(19) United States
(12) Patent Application Publication
(10) Pub. No.: US 2021/0112892 A1
(43) Pub. Date: Apr. 22, 2021

(54) METHOD FOR MANUFACTURING A PROTECTION DEVICE

(71) Applicant: DAINESE S.P.A., Colceresa (IT)

(72) Inventor: Luigi RONCO, COLCERESA (IT)

(21) Appl. No.: 17/134,991

(22) Filed: Dec. 28, 2020

Related U.S. Application Data
(62) Division of application No. 15/570,283, filed on Oct. 27, 2017.

(30) Foreign Application Priority Data
May 6, 2015 (IT) VR2015A000074

(51) Int. Cl. A41D 13/018; B60R 21/235; D04B 1/22

(52) U.S. Cl. CPC A41D 13/018; B60R 21/235; D10B 2505/124; B60R 2021/23552; D10B 2403/022; D04B 1/22

(57) ABSTRACT

A method for manufacturing a protection device is described. The protection device comprises an inflatable element configured to assume an active inflated condition and a rest deflated condition. The inflatable element includes a knitted body having a closed structure on at least four sides or walls and/or having at least a partially tubular shape, and defining an inner area or inner chamber. The knitted body includes also union threads crossing the inner chamber.

### CROSS-REFERENCE TO RELATED APPLICATIONS

The present application is a divisional of U.S. patent application Ser. No. 15/570,283, filed on Oct. 27, 2017, which is the U.S. national stage of International Patent Application PCT/IB2016/052510, filed on May 3, 2016, which, in turn, claims priority to Italian application VR2015A000074 filed on May 6, 2015, the contents of each of which are incorporated herein by reference in their entirety.

### FIELD

The present disclosure relates to a method for manufacturing a protection device, in jargon called airbag, for protecting a user. The protection device includes an inflatable element apt to protect from impacts and/or falling a passenger, a motor vehicle driver or similar user, during a sporting and/or working activity and/or any activity.

### BACKGROUND

A known protection device, such as the one described in the International patent application PCT/IB2009/055512 herein incorporated by reference, includes an element apt to assume an active inflated condition and a rest deflated condition. The inflatable element in particular is formed by a a first mesh and a second mesh. The inflatable element further includes a first sheet or first wall and a second sheet or second wall fastened with one another along respective peripheral edges which cover and coat on an outer side, respectively, the first mesh and the second mesh.

The known protection device, even if it is advantageous from several points of view, have some drawbacks which have been not yet overcome.

For example, a drawback lies in that the first mesh and the second mesh belong to a textile structure with great sizes and prefabricated, that is a structure, usually sold in rolls, wherein the two meshes are opposed and overlapped. In order to implement the protection device, the prefabricated structure is cut to length according to a drawing established in advance based upon the shape or form or airbag which one wants to obtain. Considering that the sack or inflatable element most times has particular shapes with creeks or curves to be apt to the various portions of the body of a user to be protected, if follows that, after the cut, often there is a high waste material which cannot be recovered.

Furthermore, another problem of the prefabricated structure is that the pulling threads have a pre-established length. In order to implement inflatable elements with different height, it is necessary to make available several textile structures with pulling threads having different lengths and to unite the textile structures. Such solution is an expensive solution and it requires several working phases for cutting and uniting/sewing the textile structures.

A technical problem underlying the present disclosure lies in making available a protection device for the protection of a user capable of overcoming said drawback and/or obtaining additional advantages and making available a garment including said device for the personal protection.

Such problem is solved by a protection device for the protection of a user, by a method for manufacturing a protection device and by a use according to the respective independent claims.

Secondary features of the subject of the present disclosure are defined in the respective depending claims.

### SUMMARY

The protection device according to the present disclosure characterizes in that, instead of using a prefabricated structure including two meshes, a tailored knitted body is used, based upon the shape of the inflatable element to be obtained. In other words, the protection device according to the present disclosure is implemented by means of a knitting.

Such knitting technique allows overcoming the drawback of a high material waste, since airbag portions are implemented by knitting and they belong to one single knitted body or body with three-dimensional mesh (according to the profile to be obtained) which then is not cut by a prefabricated roll.

In particular, the knitted body according to the present disclosure carries out a similar or same function of the first mesh and of the second mesh described in the above-mentioned International patent application, and it is knitted starting from a thread or tape which is knitted, according to a pre-established drawing so that there is no prefabricated material waste or that such waste is reduced to the minimum. Within the present disclosure, under the term “thread” an elongated and thin body is meant, with flexible consistency made of a material suitable for a knitting. It can even be a tape or band which can be knitted by means of a machine for knitting or knitting machine. Alternatively to the thread, even a filament can be used, comprising a plurality of threads or fibres wound on themselves, or a plurality of threads approached therebetween.

Under the expression “knitting” a working is meant allowing to obtain an in-series interlacement formed by threads, rings or small circles made of various material. The mesh can be meant as a tissue or net having a determined mesh opening.

More in particular, according to the present disclosure, it is a knitted body having, contrary to the above-mentioned International patent application, closed structure on at least four sides or walls, wherein, practically said structure has at least a partially tubular shape and defines an inner area or inner chamber. Then, it can be a knitted body defining an inner area or inner chamber, wherein the knitted body includes at least a first knitted face, that is a first side or first portion or knitted wall, at least a second knitted face, that is a second side, or second portion or knitted wall, opposite to the first face; at least a third knitted face, that is a third side or third portion or knitted wall and continuously connected by knitting to the first face and the second face on one side of such two faces; at least a fourth knitted face, that is a fourth face or fourth portion or knitted wall and continuously connected by knitting to the first face and the second face on the other side of such two faces, wherein the fourth face is opposite to the third face.

In other words, it is a body comprising at least a mesh having tubular shape. The tubular structure under a collapsed condition has two opposite and overlapped portions, which result to be connected laterally in one single body without continuity solution by means of respective connecting side portions and which then do not need seams or other connecting method. In other words, contrary to the meshes of the above-mentioned International patent application, the two opposite portions, that is the first wall and the second wall of the knitted body are continuously connected by knitting (without continuity solution) thanks to the fact that the knitted body is a three-dimensional body, at least with tubular shape, worked all together.

Furthermore, the inflatable element comprises a plurality of union threads arranged in the inner area and apt to connect at least the first portion/face and the second portion/face of the knitted body. The union threads are integrating portion of the knitted body and they act as tie rods and allow to limit a maximum expansion of the knitted body. In other words, each one of the union threads has a respective first end portion connected to the first side or wall of the worked body and a second end portion connected to the second side or wall of the knitted body. Even the union thread is to be meant as thread with any shape as defined above. The union threads then are knitted starting, too, from a thread or filament which is knitted together with the thread or filament forming the faces of the knitted body.

In other words, according to the present disclosure, the knitted body apart from the thread forming the faces of the knitted body also includes union threads having the function of tie rods, and which play the same function of the tie rod members described in the International patent application mentioned above. Even in this case the union threads are knitted with the knitted body, to form a single body therewith. The union threads are in the inner chamber and cross the latter. The union threads can be worked together with the knitted body in one single productive phase in a respective knitting machine.

The knitted body then is a so-called three-dimensional body, that is it extends at least in three directions and it is already equipped with the union threads at time of the knitting.

In other words, the union threads can be worked together with the knitted body in a knitting machine. To this purpose, at least one group of the union threads belongs to, or is made starting from, one single thread, or one single filament constituted by at least two threads, wherein the single thread or the single filament is extended alternatively continuously by knitting between the first portion and the second portion of the knitted body.

Still more preferably, the single thread or the single filament is arranged in a zigzag manner or according to a sinusoidal pattern between the first portion and the second portion of the knitted body to cover or involve at least a region of the inflatable element. The zig-zag arrangement can be meant widely, in the sense that the union threads can be arranged so as to result with a diagonal arrangement between the first portion of the knitted body and the second portion of the knitted body, or the union threads are arranged substantially orthogonal between the first portion and the second portion.

According to an embodiment of the present disclosure, thanks to the fact that the union threads are united and worked together with the knitted body by means of the same knitting machine, it is possible to adjust or program, already in the productive phase, the length of the union threads depending upon the maximum width of the inflatable element which is wanted to be obtained.

In particular, the inflatable element can comprise, in a first area, first union threads having a first length and, in a second area, second union threads having a second length, wherein the first length is different from the second length.

Similarly, according to an embodiment of the present disclosure, thanks to the fact that the union threads are united and worked together with the knitted body by means of the same knitting machine, it is possible to adjust or program, already in the productive phase, the density of the union threads, meant as number of threads per surface unit, depending upon the area of the inflatable element, for example in relation to the distance from a pressure gas generator. The inflatable element then can comprise, in a first area, for example in an area near to the gas generator, union threads distributed with a first density of threads and, in a second area, for example farer from the gas generator, union threads distributed with a second density of threads, wherein the first density of threads is different from the second density of threads, for example a greater density.

It can be noted that the above-described faces of the knitted body have mainly a supporting function for the union threads. It follows that the faces of the knitted body can be made of a different material than the material of the union threads and less resistant and less stiff of the union threads so as not to influence, or to influence to the minimum, on an overall complexity of the knitted body. The faces of the knitted body for example can be made of cotton or wool with a thread with determined title, that is yarns with very soft consistency and suitable for the insertion into a garment with a minimum impact on comfort. The union threads can be made of thread having high resistance to tensile strength. In an embodiment of the present disclosure the thread for implementing the knitted body is a 50 polyester thread, whereas the thread of the union thread is 75 polyester thread.

Preferably, in an embodiment of the present disclosure, the knitted body is a body having bag-like structure, that is a structure closed on at least five sides, and having only one open area, or opening or accessing mouth to access an area inside the knitted body.

In other words, according to this last embodiment, the knitted body includes a fifth side or fifth portion/face or knitted wall, wherein the fifth side is connected continuously by knitting to the first side or first portion/face, the second side or second portion/face, the third side or third portion/face and the fourth side or fourth portion/face. Such bag-like structure having one single accessing opening has the advantage of allowing to access the inner area of the knitted body to position possible technical instruments or devices inside the same inflatable device, such as for example a pressure gas generator, sensors and/or electronics for managing the protection device. Should it not be necessary to arrange anything inside the inflatable element, the knitted body can even be a closed casing on all sides, like a balloon made of meshes and collapsed on itself to form two main layers overlapped and united therebetween on the whole periphery in single body. In other words, according to this last embodiment, the knitted body includes a sixth side or sixth portion/face or knitted wall and continuously connected by knitting to the first side or first portion, the second side or second portion/face, the third side or third portion/face and the fourth side or fourth portion, wherein the sixth side or sixth portion/face is substantially opposite to the fifth side or fifth portion/face.

It is to be meant that thanks to the fact that the knitted body is worked with a knitting machine, even the possibility of weaving or knitting electric cables for inner sensors, for example pressure sensors, or for the connection with the managing electronics, should it be inserted inside the knitted body, can be provided.

In order to retain an inflating fluid in the inner chamber of the knitted body, several alternative solutions may be provided.

For example, the mesh can be worked so closely that the mesh openings of said knitted body are at least partially closed to retain at least temporarily an inflating fluid in said inflatable element.

Alternatively, the meshes can be welded therebetween after knitting to form a barrier for the inflating fluid.

It is to be meant that the knitted body should not be necessarily implemented so as to be impermeable in absolute way to the inflating fluid, but it is sufficient that the knitted body can remain under inflated condition for a sufficient period of time during the impact.

The mesh openings can be also closed and covered by means of a covering layer or a cover sheet apt to cover an outer surface of said knitted body. The covering layer can be made of any suitable material, such as for example a resin which is spread on an outer surface of the knitted body.

Alternatively or in combination with the previous embodiments, the knitted body can be further comprised or included inside an outer covering casing which can be made of a material impermeable to a gas under pressure or, generally, a material capable to resist to determined gas pressures.

In an embodiment of the present disclosure, the outer cover is implemented like the one described in the above-mentioned International application and formed by a first wall or first sheet and a second wall or second sheet connected therebetween along a periphery, for example by means of gluing.

A method for manufacturing a knitted body as the one described above, for example, provides using a so-called machine for a three-dimensional knitting and known to a person skilled in the art. Preferably it is a knitting machine having two needle beds or including a first needle bed and a second needle bed. It follows that according to the latter embodiment the above-mentioned first side, or first portion or knitted wall is a side of the knitted body worked on a first needle bed of a knitting machine having two needle beds and said second side, or second portion or knitted wall is a side of the knitted body worked on a second needle bed of said knitting machine.

Preferably, it is a rectilinear knitting machine which is capable of knitting in three dimensions and preferably even of uniting the mesh by means of a thread passing transversally inside the dimensional structure and connecting walls or areas of the knitted body, to form the above-mentioned union threads.

In other words, according to an embodiment of the present disclosure, the knitted body can be implemented automatically and with very quick productive time by means of rectilinear knitting machines known in the field of the machines intended to implement garments of three-dimensional type, for example the rectilinear knitting machines intended to implement meshes in one single body, such as for example gloves or socks.

For example, a rectilinear knitting machine includes at least two needle beds and it is capable of transferring the meshes of a knitted tissue between the needle beds. Such machine can be configured to perform a step of knitting the mesh on a first needle bed, a step of knitting the mesh on a second needle bed and a step of performing the knitting on a needle bed and on the other needle bed so that the tissue knitted on the first needle bed and the tissue knitted on the second needle bed are connected to each other by means of the union yarn.

In practice, the knitted body is implemented by working alternatively by means of a first thread guide a first thread on the needles of the first needle bed (to form a mesh ranking) and on the needles of the second needle bed (to form the remaining mesh ranking), so as to obtain a complete mesh turn, and then, after some complete mesh turns, the above-mentioned substantially tubular shape, or shape like a tubular mantle, of the knitted body. The rectilinear knitting machine may include a second thread guide which brings the second thread (intended to form the plurality of the union threads) alternatively between the first needle bed and the second needle bed to connect the union thread between the two opposite portions of the knitted body.

The rectilinear knitting machine can be programmed so as to control the length of the union thread and then to adjust the maximum height which the inflatable element can reach under inflated condition.

The fact of using a knitting machine for manufacturing a knitted body with the union threads allows calibrating according to needs the threads thereof the knitted body is made. In particular the tubular mantle and the possible additional side walls of the knitted body can be made of a soft and light material, as above anticipated, so as to reduce to the minimum the impact on an overall weight and to optimize the comfort of the personal protection device. The union threads can be made of a material with higher resistance to tensile strength.

Furthermore, the machine for knitting can be programmed to vary the length and density of the union threads based upon the portion of the protection device wherein they are. In other words, the protection device can include portions intended to protect different areas of a user's body or intended to protect as many parts or portions of a body. It follows that the protection device portions can require a different configuration in terms of overall height or stiffness of protection device under inflated condition. Such material variety and differentiation, length of the union threads or density of the union threads, and/or number of mesh threads can be controlled by means of suitable configuration of the machine for the rectilinear knitting and the variation can be even punctual between a mesh stitch and an adjacent mesh stitch.

For example at side areas (for example near the above-mentioned third face and/or of the above-mentioned fourth face) or folding areas of the knitted body, the union threads can have a lower overall length than the one of the remaining union threads, so as not to leave dead and not inflated areas when the inflatable element is put in tension.

In case to further modulate the bag's stiffness the insertion of stiff portions inside or outside the knitted body can be provided.

With reference to the cover, as said the cover coating the knitted body can be implemented according to a technique known in the field and capable of coping with quick inflations of the inflatable element, in very quick time in the order of milliseconds, and still more in particular between 10 and 500 milliseconds, preferably between 10 and 200 milliseconds, still more preferably to obtain overpressures (with respect to the atmospherical pressure) comprised between 0.5 and 3 bar.

To this regard, in an embodiment, the personal protection device includes means for activating and means for inflating the inflatable element, that is one or more sensors capable of detecting the unexpected event, and valves capable of connecting the inner chamber of the inflatable element with a source of inflating fluid. The source of inflating fluid preferably comprises a generator of cold gas, such as for example helium, that is a container wherein the gas is kept at a high pressure.

It is to be noted that the knitting technique according to the present disclosure can be used for manufacturing a garment which, in a single body, includes the inflatable element. In fact, the machine for knitting can be used for manufacturing a garment (even in one single tissue layer), and programmed for creating in a determined garment area a double layer of tissue with union threads corresponding to the above-mentioned knitted body with tubular shape. The area of the double layer made of tissue can be coated with a cover apt to retain an inflating fluid. Cover sheets or layers can be placed on both sides and closed peripherally around the double layer by providing suitable openings in the tissue layer allowing a mutual gluing of the two covering layers or sheets.

Alternatively, the inflatable element is included in a garment or sub-garment, for example received in a pocket of the garment or the sub-garment.

Still alternatively, the inflatable element coincides with the garment or with the sub-garment, that is the garment or the sub-garment is implemented as a knitted body and with union threads, and equipped with activating and inflating means.

Other advantages, features and use modes of the subject of the present disclosure will result evident from the following detailed description of some preferred embodiments thereof, given by way of example and not for limitative purposes. It is however evident that each embodiment can have one or more of the above-enlisted advantages; in each case it is not requested that each embodiment has simultaneously all enlisted advantages.

### BRIEF DESCRIPTION OF THE DRAWINGS

The figures of the enclosed drawings will be referred to, wherein:

FIG. 1 shows a top view of a protection device rested on a plane and manufactured according to the present disclosure;

FIG. 2 shows a section view according to the line II-II of FIG. 1;

FIG. 3 shows a detail III of FIG. 2;

FIG. 4 shows a detail IV of FIG. 2;

FIG. 5 shows a top view of a knitted body according to the present disclosure;

FIG. 6 shows a view of a step for manufacturing a protection device according to the present disclosure wherein a knitted body is associated to a cover.

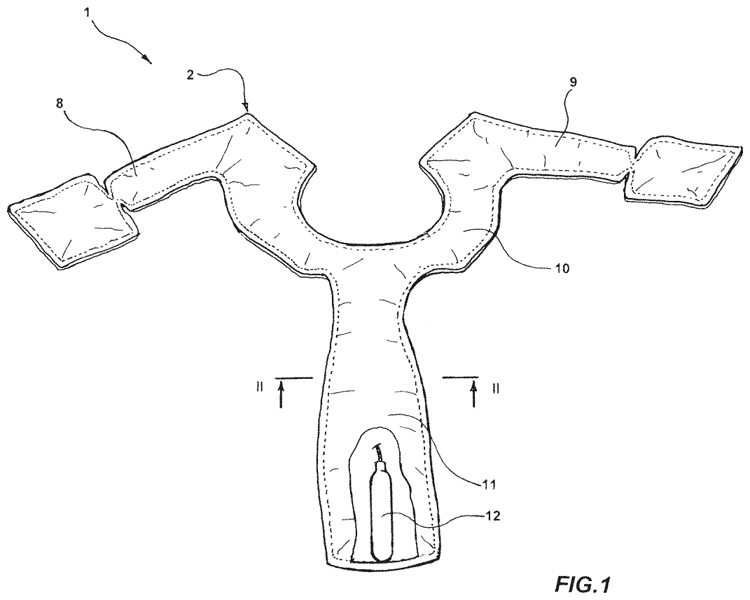

By referring to the enclosed figures, with the reference number 1 a protection device according to the present disclosure is designated in agreement with a specific and exemplifying embodiment.

### DETAILED DESCRIPTION

In particular, the protection device 1 comprises an inflatable element 2 apt to assume substantially a first rest condition or deflated condition, and a second active condition or inflated condition. The modes for inflating the inflatable element 2 will be described hereinafter in the description.

The protection device 1 comprises a knitted body 3 having in the example a closed structure, that is it is a substantially casing-like shaped body, that is a three-dimensional structure at least with tubular shape, and preferably mainly closed on five sides or on all sides and defining an inner area or chamber 4.

In the illustrated embodiment the knitted body 3 is a substantially bag-like shaped body having one single opening 6 allowing the access to the inner area 4.

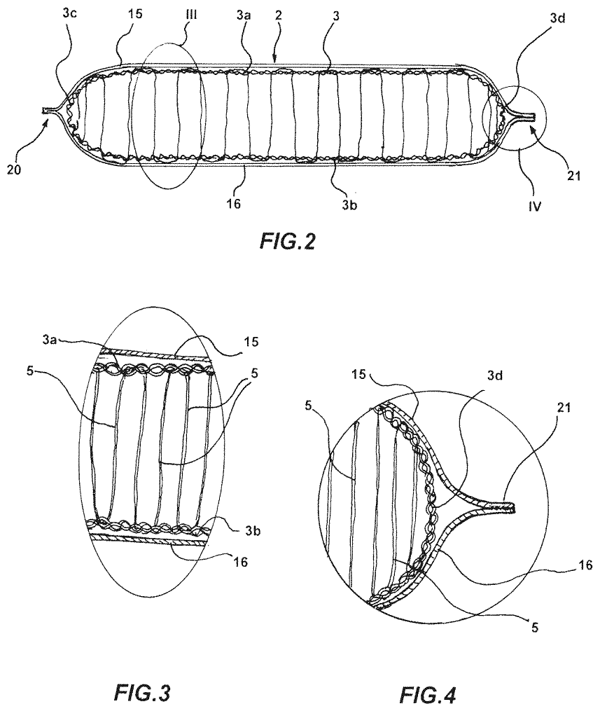

The knitted body 3 then, when laid on a plane and pressed in such extended position, includes two opposite portions/faces or walls 3a, 3b and at least three side portions/faces 3c, 3d, only two thereof can be seen in FIGS. 2 and 4 extending without continuity solution between the two opposite portions 3a, 3b.

Thanks to the tubular shape, and still better thanks to the shape like closed bag or casing, the knitted body 3 has the advantage of being closed laterally on at least two sides (at the side portions 3c, 3d) and not requesting a seam at least on said two sides, as for example described in the above-mentioned International patent application.

In the example illustrated in the drawings, the inflatable element 2 has a shape with two side wings 8, 9 for covering the shoulders of a user, a central portion shaped substantially like a “C” 10 and a spinal portion 11, intended to protect the spine of the user. The knitted body 3 has a shape re-using and following the shape of the inflatable element 2 and it is implemented in one single body according to said shape to define a single inner area 4.

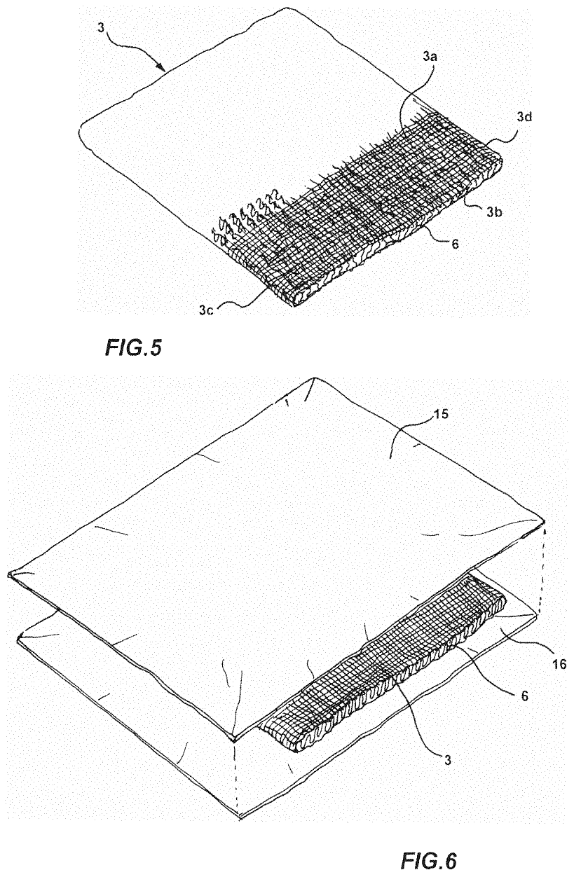

In FIG. 5 and in FIG. 6, the knitted body 3, in schematic way, show a substantially rectangular shape in order to show how this is coated and covered by means of a cover. It is to be meant, as said, that the knitted body 3 can have or show a shape corresponding to that of the inflatable element 2 to be obtained.

In the illustrated embodiment, the spinal portion 11 can have said access opening 6 to allow positioning inside the inner area 4 a gas generator under pressure 12. Practically, the gas under pressure is introduced starting from the spinal portion 11.

The knitted body 3 further includes a plurality of union threads 5 or pulling threads distributed in the inner chamber 4 and firmly connected to respective portions 3a, 3b of the knitted body 3, in particular to surface portions of the same.

The union thread 5 is an element or entity having the function of keeping united or constrained or fixed, being tensioned to tensile strength, two or more portions of the knitted body 3, at least when the latter is under inflated condition. It is noted that in the illustrated embodiment the plurality of union threads 5 is obtained starting from or belongs to one single thread, or one single filament constituted by at least two threads, wherein the single thread or the single filament is extended alternatively continuously by knitting between the first portion 3a and the second portion 3b of the knitted body 3. The thread thereof the union threads are made is a different thread or filament from that thereof the faces of the knitted body are made.

Still more in particular, the single thread or the single filament is arranged in a zigzag manner or according to a sinusoidal pattern between the first portion 3a and the second portion 3b of the knitted body 3 to cover or occupy a region of the inflatable element 2.

The union threads 5 are suitably sized so that, when the inflatable element 2 is under rest condition, preferably they are not subjected to tension and they are collapsed in the inner chamber 4, whereas when the inflatable element 2 is under inflated condition they are subjected to tension. The threads can be arranged so as to connect opposite portions 3a, 3b of the knitted body 3 or they can be arranged diagonally so as to connect not opposite portions of the knitted body 3.

The threads are distributed closely for example with a density of at least a pulling element each cm² of surface of the inner chamber 4, still more preferably, still by way of example, with density comprised between 1 and 15 threads each cm² of surface of the inflatable element 2, preferably between 4 and 6 threads each cm². The distribution of the threads can be varied according to the protection device area wherein the threads are. The union threads 5 for example can be made of polyester or polyamide, with thickness comprised between about 500 and about 1000 decitex (length unit of a continuous thread or a yarn). Each thread 5 can include a beam of continuous fibres without twist which outgo from a single point of a respective mesh of the knitted body 3.

In an embodiment of the present disclosure, the yarns used to implement the union threads 5 are yarns of different type with respect to those used for implementing the casing-like body and the above-mentioned portions 3a, 3b, 3c, 3d. In particular the union threads are made of a material having greater resistance to tensile strength than the threads of the casing-like body. The threads of the casing-like body can be made of a softer material, so as to obtain an inflatable element which is soft as much as possible and has a light and flexible consistence which is of total comfort for a user wearing it.

The threads of the knitted body 3 can be made of a material variable and differentiated even based upon the area of the protection device wherein they are and upon the area of the body of a user to be protected, for example the union threads 5 have a shorter length in a region of the inflatable element adjacent to the third portion/face 3c and/or the fourth portion/face 3d with respect to a central area of the inflatable element far from the third portion/face 3c and/or the fourth portion/face 3d.

The knitted body 3 and the union threads 5 can be implemented with a machine for knitting, or rectilinear knitting machine of known type which includes two needle beds, that is two rows of needles intended to the working of the knitted body. A knitting machine of known type is a machine for gloves as the one with code SWG0991N by Shima Seiki.

The two needle beds have a field of needles having an extension or length corresponding to a shape size, such as for example width or shape length, of the inflatable element to be obtained, corresponding to one of the two portions 3a or 3b comprised between the portions 3c and 3d for example. The machine is equipped with a first thread guide supporting a first thread intended to form the knitted body 3 and a second thread guide carrying a second thread intended to form the union threads 5.

The machine can be programmed so as to implement the knitted body 3 by means of the first thread guide which works alternatively the thread on the first needle bed of needles and on the second needle bed of needles.

The machine can be programmed so as to unite two opposite areas 3a, 3b of the mesh by means of the second thread carried by the second thread guide, to form the union threads 5. For example the machine can be programmed to work some mesh ranks, so as to form some complete mesh turns, and subsequently to unite by means of the second thread guide, and then the second thread, determined needles of the first needle bed with determined needles of the second needle bed. Subsequently, some mesh turns are worked again to repeat then the knitting with the second thread forming the union threads.

In order to define a specific length of the union thread, it is possible to unite the meshes by means of diagonal union threads. In this case the second thread guide will interlace the union thread with determined needles of the first needle bed and of the second needle bed so that the union threads are arranged diagonally between the needles of a first needle bed and the needles of a second needle bed.

Alternatively, the mesh can be worked with a “needle-discarding” technique wherein, for each needle bed one provides using some needles as “operating” needles intended for knitting and then involved by the working of the meshes of the knitted body, and other “not operating” free needles, not involved by the knitting. Such kept-free “not operating” needles allow receiving temporarily the union thread. Practically, the union thread is “parked” momentarily on the “not operating” needle when it is worked between the first needle bed and the second needle bed. In particular, the union thread is knitted on an “operating” needle of the first needle bed intended for the working of the meshes, then it is “parked” on a “not operating” needle of the same first needle bed and subsequently it is worked on an “operating” needle of the second needle bed. In this way, by programming the distance between the first “operating” needle of the first needle bed, the not operating needle of the first needle bed and the “operating” needle of the second needle bed, it is possible establishing in advance the length of the union threads 5 when the knitted body is removed from the knitting machine.

It is to be meant that a person skilled in the use of the rectilinear knitting machines can be able to program the machine in the most optimum way to obtain the wished result.

Additional information about the working of a knitted body by means of union threads can be traced in the Italian patent application TO-2013-A-472, which describes the implementation of knitted bodies equipped with union threads.

It is further to be noted that the rectilinear knitting machine can further be programmed to vary the length of the union thread according to the area of the inflatable element to be implemented. For example, in an area of the knitted body 3 intended to be placed at the peripheral areas or areas 3c, 3d of the inflatable element 2, the union threads 5 can have a length which reduces gradually up to the minimum, in order to guarantee a tension of the union threads 5 even at the peripheral areas when the inflatable element 2 is inflated.

Furthermore, the rectilinear knitting machine can further be programmed to vary the mesh opening, for example by modifying the programming of the discarded needle, or when a closer mesh is required by using a double thread for implementing the mesh.

An important aspect deriving from the fact that the knitted body 3 is obtained in a single working step lies in the fact that it is not necessary to provide peripheral seams in the meshes as on the contrary it was provided in the above-mentioned International patent application.

The knitted body can be further coated and covered by a cover.

The cover can include two walls 15, 16 or sheets made of a sheet of soft and gas-tight material, for example of polyamide or polyurethane, which are opposite one with respect to the other one, and fastened peripherally along respective peripheral edges 20, 21.

The walls 15, 16 can be like those described in the above-mentioned International patent application and they can be made of a laminate, which is usually used as a garment lining and including a layer of fabric, in the example nylon 100% (representing about 65% in weight of the laminate) and a layer of glue, in the example a film of glue (representing about 35% in weight of the laminate), for example polyurethane glue, distributed onto the layer of fabric, by means of roller spreading.

The knitted body 3 is firmly fastened to the surface of the respective wall 15, 16, by means of a film of glue (not visible in the figures). In case of using the above-mentioned laminate, the film of glue is arranged in contact with the layer of glue of the laminate.

The just described protection device is implemented in the following way according to an embodiment.

The knitted body 3 is arranged under extended condition, so that the two opposite portions 3a, 3b are collapsed one onto the other one. The knitted body 3 in such configuration is arranged between two walls 15, 16 and fastened adhering to a respective wall 15, 16, for example by means of glue.

Subsequently, respective opposite peripheral edges 20, 21 of the walls 15 and 16 are overlapped one onto the other one along the periphery.

From the above-mentioned description it comes out that the two walls 15 are 16 substantially are two opposite elements or sheets of the inflatable element 2, fastened along the respective peripheral edges 20 and 21. In any case there is nothing to prevent the two walls 15 and 16 from being opposite portions of one single book-like folded sheet, and then having peripheral edges extended along a portion of the periphery and closed by means of sealing tape.

To implement the inflation of the inflatable element 2, in case of unforeseen fall and/or slide and/or impact by a user or a vehicle whereon he/she proceeds, the protection device 1 according to the present invention is apt to cooperate with suitable activation means operatively connected to inflation means, thereof in figures by purely way of illustration a compressed cold gas cylinder 12 is illustrated, connected by means of a duct or cannula to an intercept valve, fastened to the inflatable element 2, which allows inserting an inflating fluid into the inflatable element 2.

The gas cylinder 12, as above indicated, can be also included inside the inflatable element 2.

Alternatively, such inflating means can include gas generators of pyrotechnic type or hybrid type or other types known to the state of art.

Said inflating means is controlled by a control unit based upon the detection of the status of the vehicle/driver system; for example said control unit can implement a system for predicting the fall allowing to timely identify the fall event and a reliable prediction thereof by means of accelerometric sensors integral to the vehicle (or the driver) and a unit for processing the signals produced by the sensors themselves.

Alternatively, the device according to the present disclosure can also be applied by using an activation cable connected to a vehicle guided by a user, which cable controls the inflation of the inflatable element 2 after the removal of the user from the vehicle, for example, after a fall or an unforeseen impact.

In any case, the above-mentioned activating and inflating means can be integrated in the protection device 1 according to the present invention or placed outside the same.

It is to be also noted that the activation modes, even if they are an aspect of particular relevance for an effective operation of the device, will not be further described with greater detail as they are methods mainly already known to the person skilled in the art of the protection of a subject from unforeseen impacts.

The knitted body 3 can include even electric threads which can be knitted together with the knitted body for the connection of inner/outer sensors and/or managing electronics or valves or other electric devices.

It is further to be noted that the protection device can be included in a garment, or it can be integrating portion of a garment. In fact, there is nothing to prevent that, thanks to the programming potential of a rectilinear knitting machine, from implementing in one single producing step a knitted body together with a garment, that is that the knitted body is integrated in one single body with the garment, or even coincides with the garment. In fact for example the knitted body can have a vest-like or jacket-like shape and, for example, worked with a mesh density so as to allow an adequate fluid-tightness of the inflating gas.

In order to make the knitted body impermeable or at least with temporary fluid-tightness, the implementation of a localized cover of the knitted body, or the implementation of a closer mesh at the knitted body, can be provided.

Two covering layers can be provided on opposite sides of the knitted body, and such covering layers can be united by means of suitable openings provided around the knitted body.

The subject of the present disclosure has been so far described with reference to preferred embodiments. It is to be meant that other embodiments belonging to the same inventive core may exist, all within the protection scope of the here below enclosed claims.

1. A method for manufacturing a protection device to be worn by a user, the method comprising:
knitting an inflatable three-dimensional unitary knitted body having an inner chamber that is configured to assume an inflated condition for protection of the user, and a deflated condition at rest, the inflatable three-dimensional unitary knitted body being knitted by a rectilinear knitting machine, wherein:
in the inflated condition, the inner chamber is defined by at least a partially tubular shape;
in the deflated condition, the inner chamber is defined by overlapping opposite regions of said inflatable three-dimensional unitary knitted body; and
the knitting comprises forming a plurality of union threads in said inflatable three-dimensional unitary knitted body by said rectilinear knitting machine, the plurality of union threads occupying the inner chamber and connecting the overlapping opposite regions.

2. The method according to claim 1, wherein the knitting further comprises:
adjusting a length of the union threads according to a region of the inflatable three-dimensional unitary knitted body.

3. The method according to claim 2, wherein the adjusting comprises shortening the length of the union threads in a region of the inflatable three-dimensional unitary knitted body away from a central area of said knitted body.

4. The method according to claim 1, wherein the forming of the union threads comprises:
continuously extending a thread in an alternate manner between the overlapping opposite regions of the inflatable three-dimensional unitary knitted body.

5. The method according to claim 4, wherein the thread extends in the alternate manner, in a zigzag or a sinusoidal pattern, between said overlapping opposite regions.

6. The method according to claim 1, wherein the knitting further comprises:
knitting on a first needle bed, a first portion of the overlapping opposite regions via a first thread carried by a first thread guide;
knitting on a second needle bed, a second portion of the overlapping opposite regions via the first thread carried by the first thread guide; and
connecting by knitting the first portion of the overlapping opposite regions on the first needle bed with said second portion on the second needle bed via a second thread carried by a second thread guide,
wherein the rectilinear knitting machine includes at least the first needle bed and the second needle bed.

7. The method according to claim 6, wherein the first thread is made of a different material than the second thread.

8. The method according to claim 7, wherein the first thread is made of a material that is softer and less resistant to tensile strength compared to a material of the second thread.

9. The method according to claim 1, further comprising:
covering or coating an outer surface of said an inflatable three-dimensional unitary knitted body.

10. The method according to claim 1, wherein the inflatable three-dimensional unitary knitted body is included in a garment or a sub-garment.

11. The method according to claim 1, wherein the inflatable three-dimensional unitary knitted body is shaped as a garment or a sub-garment.

12. The method according to claim 1, wherein the inflatable three-dimensional unitary knitted body is a closed body that defines a closed casing.

13. The method according to claim 1, wherein the knitting further comprises:
forming mesh openings of said inflatable three-dimensional unitary knitted body that are at least partially closed or covered to retain at least temporarily an inflating fluid in said knitted body.

14. The method according to claim 1, further comprising:
covering an outer surface of said knitted body with a covering layer or a cover sheet.

15. The method according to claim 14, wherein the covering layer or the cover sheet is made of a material comprising a resin.

16. The method according to claim 14, further comprising:
arranging the inflatable three-dimensional unitary knitted within an outer covering casing made of a material capable to resist a predetermined gas pressure.

17. The method according to claim 1, wherein:
the protection device is a wearable garment producible by the rectilinear knitting machine, and
the method further comprises:
programming the rectilinear knitting machine for forming in an area of the wearable garment a double layer of tissue corresponding to said overlapping opposite regions of the inflatable three-dimensional unitary knitted body with the plurality of union threads, and
coating said area of the wearable garment with a cover apt to retain an inflating fluid.

18. The method according to claim 17, wherein said area of the wearable garment is part of a pocket of the wearable garment.
